(19) United States
(12) Patent Application Publication
(10) Pub. No.: US 2025/0074015 A1
(43) Pub. Date: Mar. 6, 2025

(54) TECHNIQUES FOR RELEASE OF COMPOSITE MATERIAL FROM FORM LAYUP TOOL

(71) Applicant: Textron Innovations Inc., Providence, RI (US)

(72) Inventors: Dave Carlson, North Richland Hills, TX (US); John Jones, North Richland Hills, TX (US); Matt Yancey, Weatherford, TX (US); Billy Benda, Granbury, TX (US); Jeramy Gutierrez, Ft. Worth, TX (US); Robert Suggs, Saginaw, TX (US)

(73) Assignee: Textron Innovations Inc., Providence, RI (US)

(21) Appl. No.: 18/456,858

(22) Filed: Aug. 28, 2023

(51) Int. Cl. B29C 70/34; B29C 70/56

(52) U.S. Cl. CPC B29C 70/342; B29C 70/56; B29L 2031/3076

(57) ABSTRACT

A method of forming a composite part is described and includes connecting a layup form tool to a vacuum source; overlaying a release film on a surface of the layup form tool; engaging the vacuum source to affix the release film to the surface of the layup form tool using vacuum pressure; overlaying at least one sheet of composite material on the release film affixed to the surface of the layup form tool to form the composite part; and removing the formed composite part from the layup form tool.

### STATEMENT REGARDING FEDERALLY SPONSORED RESEARCH OR DEVELOPMENT

This invention was made with U.S. Government support under Agreement No. W9124P-19-9-0001 awarded by the Army Contracting Command-Redstone Arsenal to the AMTC and a related AMTC Project Agreement 19-08-006 with Bell Textron Inc. The Government has certain rights in the invention.

### TECHNICAL FIELD

This disclosure relates in general to the field of aircraft and, more particularly, though not exclusively, to techniques for facilitating release of composite material from a form layup tool used in fabricating composite parts for such aircraft.

### BACKGROUND

“Composite prepreg,” or simply “prepreg,” is a composite material comprised of preimpregnated fibers and a partially cured polymer matrix, such as epoxy or phenolic resin, for example. The fibers may take the form of a weave, with the polymer matrix being used to bond the fibers to each other and to other components during manufacture. Composite structures, such as aircraft parts, comprised of prepregs will most often require a curing process after layup on a shaped form tool.

Industry standard procedure for layup and cure of composite prepregs involves the application of sheets of uncured composite prepreg material to shaped form tools. The sheets are compacted on the form tool and subsequently cured to create a composite part. This process takes advantage of the tacky, or sticky, nature of composite prepreg by allowing it to be reshaped while securely adhered to the surface of the form tool. While this process works well when the prepreg material is shaped and cured on the same form tool, it becomes problematic in situations in which the composite material must be shaped on one form tool and subsequently transferred to a different tool on which the material will be cured. In this situation, the tacky nature of the composite material prevents its easy release from the form tool such that it must be forcibly peeled from the form tool for transfer to a cure tool. Such peeling often results in unacceptable distortion and/or damage to the composite laminate and unusable part.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1A illustrates a perspective view of a tiltrotor aircraft in helicopter mode, according to one example embodiment;

FIG. 1B illustrates a perspective view of a tiltrotor aircraft in airplane mode, according to one example embodiment;

FIG. 2 illustrates a composite part that has undergone significant distortion due to conventional techniques used to remove the composite part from a form tool;

FIG. 3 illustrates a schematic block diagram of a form layup tool system use in connection with techniques for release of composite material from a form layup tool in accordance with features of embodiments described herein;

FIG. 4 illustrates a perspective view of the form layup tool system of FIG. 3;

FIG. 5 illustrates a perspective view of the form layup tool system of FIG. 4 after release film has been overlaid thereon in connection with techniques for release of composite material from a form layup tool in accordance with features of embodiments described herein;

FIG. 6 illustrates a perspective view of the form layup tool system of FIG. 5 after composite material has been laid up thereon in connection with techniques for release of composite material from a form layup tool in accordance with features of embodiments described herein;

FIG. 7 illustrates a perspective view of a composite part formed using the form layup tool system of FIG. 5 after the part has been removed from the form layup tool using techniques for release of composite material from a form layup tool in accordance with features of embodiments described herein; and

FIG. 8 is a flow diagram illustrating operations performed in connection with techniques for release of composite material from a form layup tool in accordance with features of embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this Specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

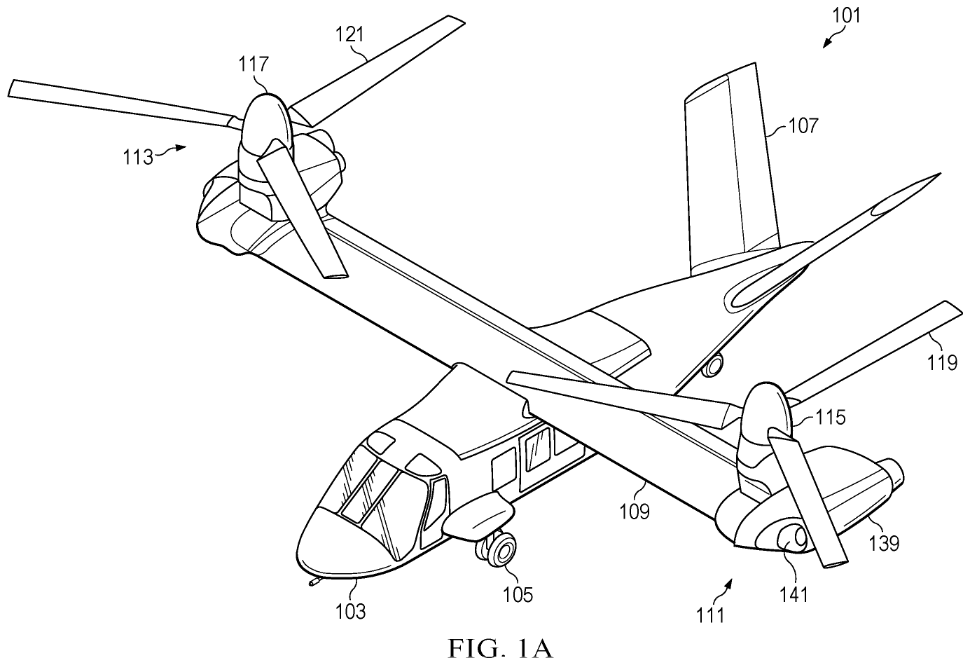

FIGS. 1A and 1B in the drawings illustrate a tiltrotor aircraft 101, according to one example embodiment. Tiltrotor aircraft 101 can include a fuselage 103, a landing gear 105, a tail member 107, a wing 109, a drive system 111, and a drive system 113. Each drive system 111 and 113 includes an engine and/or motor (e.g., engine 139) and a rotatable proprotor 115 and 117, respectively. Each rotatable proprotor 115 and 117 have a plurality of rotor blades 119 and 121, respectively, associated therewith. Rotor blades 119, 121, are connected to respective rotor masts (not shown in FIGS. 1A and 1B) to which rotational energy is applied by respective engines or motors. It will be recognized that each drive system 111, 113, may include appropriate gear boxes for transferring energy between the engine/motor and the rotor mast. The position of proprotors 115 and 117, as well as the pitch of rotor blades 119 and 121, can be selectively controlled in order to selectively control direction, thrust, and lift of tiltrotor aircraft 101.

FIG. 1A illustrates tiltrotor aircraft 101 in helicopter mode, in which proprotors 115 and 117 are positioned substantially vertically to provide a lifting thrust. FIG. 1B illustrates tiltrotor aircraft 101 in an airplane mode in which proprotors 115 and 117 are positioned substantially horizontally to provide a forward thrust in which a lifting force is supplied by wing 109. It should be appreciated that tiltrotor aircraft can be operated such that proprotors 115 and 117 are selectively positioned between airplane mode and helicopter mode, which can be referred to as a conversion mode.

The drive system 113 is substantially symmetrical to the drive system 111; therefore, for sake of efficiency, certain features will be disclosed only with regard to drive system 111. However, one of ordinary skill in the art would fully appreciate an understanding of drive system 113 based upon the disclosure herein of drive system 111.

Further, drive systems 111 and 113 are illustrated in the context of tiltrotor aircraft 101; however, drive systems 111 and 113 can be implemented on other tiltrotor aircraft. For example, an alternative embodiment may include a quad tiltrotor that has an additional wing member aft of wing 109; the additional wing member can have additional drive systems similar to drive systems 111 and 113. In another embodiment, drive systems 111 and 113 can be used with an unmanned version of tiltrotor aircraft 101. Further, drive systems 111 and 113 can be integrated into a variety of aircraft configurations. Additionally, other drive systems are contemplated. For example, one example is a gearbox arrangement to provide torque to a rotor system of a helicopter.

Composite materials are widely used in the aircraft industry because they may provide structural strength comparable to metal alloys but are lighter weight than such materials, leading to improved fuel efficiency, temperature-resistance, and aircraft performance. Composites may be viewed as a sort of hybrid material that has improved structural properties over its individual components. Examples of composite materials that may be used in aircraft applications include layered combinations of carbon fiber or Kevlar @ and plastic resin.

Composite materials can be formed into various shapes, with the fibers wound tightly to increase the strength of the material. Additionally, composites can be layered such that the fibers in each layer run in a different direction, thereby allowing design of structures with properties unique to the function of the structure. For example, a structure can be designed so that it will bend in one direction, but not another. Examples of aircraft structures, or parts, that may be constructed of composite materials include, but are not limited to, engine blades, brackets, nacelles, propellers, rotors, and wings.

As noted above, industry standard procedure for layup and cure of composite prepregs during the construction of aircraft components involves the application of sheets of uncured composite prepreg material to shaped form tools. The sheets are compacted on the form tool and subsequently cured to create a composite part. This process takes advantage of the tacky, or sticky, nature of composite prepreg by allowing it to be reshaped while securely adhered to the surface of the form tool.

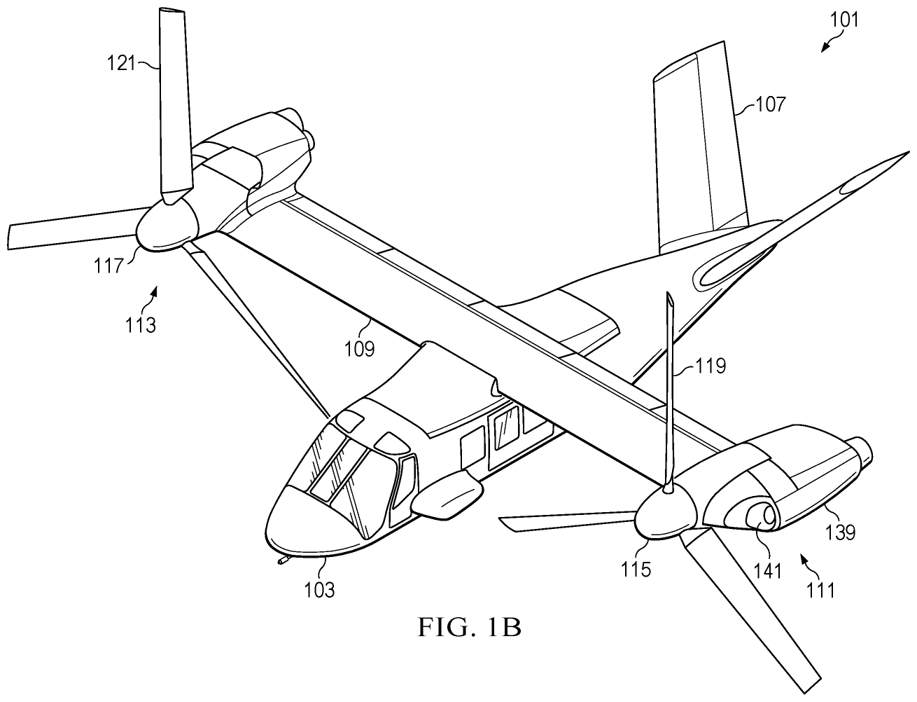

One conventional method for releasing tacky composite material from a form, or layup, tool includes physically forcibly peeling the material from the tool using hand tools or blades. As previously noted, and as illustrated in FIG. 2, this can cause unacceptable distortion of the formed laminate 200 from the intended shape 202 and/or damage to the form tool itself. Another conventional method for releasing tacky composite material from a form tool may include applying an adhesive backed nonstick coating or film to the forming shape to enhance release. Although this method is somewhat of an improvement of the previously described method, it fails to fully prevent unacceptable distortion to the formed laminate. Additionally, the adhesive backed release film is easily damaged by the hand tools needed to remove the formed composite material from the form tool and is difficult and time consuming to replace.

In accordance with features of embodiments described herein, a vacuum chuck holding fixture is used as a vacuum surface for positively securing a non-perforated release film for composites to surface of the fixture. In some embodiments, the non-perforated release film may be a high performance fluoropolymer release film. In particular embodiments, a porous granular material, which in particular embodiments may be implemented as VACU-GRIP™, available from Technical Tooling, LLC, of Tacoma, Washington, is machined or otherwise manipulated to the desired shape of the composite part form tool. In particular, the porous granular material enables uniform vacuum across the full surface area comprising the material when vacuum pressure is applied thereto. The material further conforms to complex geometries, such as required by form tools for aircraft components. The material provides consistent contact area support while simultaneously pulling full vacuum across the full surface area.

Before beginning layup of composite laminate material on the porous form tool, a top surface of the form tool is covered with a thin sheet of non-perforated release film. Vacuum is then applied to the form tool by a vacuum source, causing the release film to be drawn tight against the top surface of the form tool. The vacuum-sealed release film on top of the porous granular material provides a rigid and secure surface for layup of composite prepreg material. Upon completion of the composite layup, the vacuum source to the porous tool is disengaged and the release film and formed composite part may be lifted off the form tool with no disturbance or distortion of the composite laminate. The as-formed composite part can then be transported to a cure tool for curing.

As will be described in greater detail below, using a form tool constructed from a granular porous material, such VACU-GRIP™ material or another material that provides the characteristics described above, when properly plumbed to a vacuum source and appropriately masked, or taped, provides an evenly distributed large surface area vacuum chuck or work holding surface for securing a work piece.

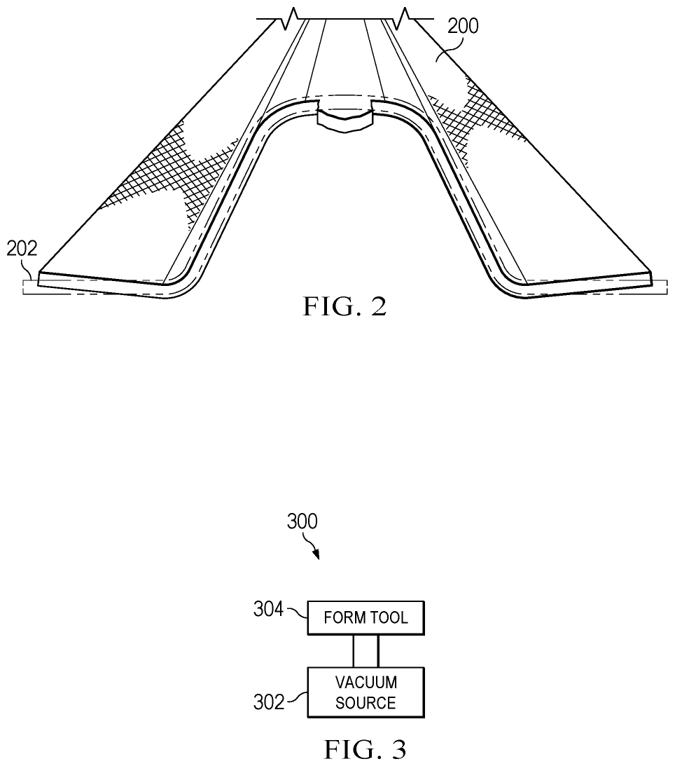

FIG. 3 illustrates a schematic block diagram of a form layup tool system, or fixture, 300 for use in connection with techniques for release of composite material from a form layup tool in accordance with features of embodiments described herein. As shown in FIG. 3, system 300 includes a vacuum source 302, which when engaged applies vacuum pressure to a layup form tool 304. In particular embodiments, vacuum source 302 may comprise a vacuum chuck. Vacuum source 302 may comprise a table or other surface on which form tool 304 is supported. In accordance with features particular embodiments, form tool 304 is formed in whole or in part from a porous granular material, such as VACU-GRIP™ (described above). Form tool 304 is machined, shaped, or otherwise manipulated into to a shape of a composite part, such as an aircraft component, to be formed using the form tool. Application of vacuum pressure to form tool 304 by vacuum source 302 results in a material laid on surfaces comprising the porous granular material portion(s) of form tool 304 to be drawn into airtight contact with those portions as long as the vacuum source 302 is engaged and vacuum pressure is applied. Conversely, when vacuum source 302 is disengaged, the material laid on surfaces comprising porous granular material portion(s) is released from airtight contact with the form tool 304.

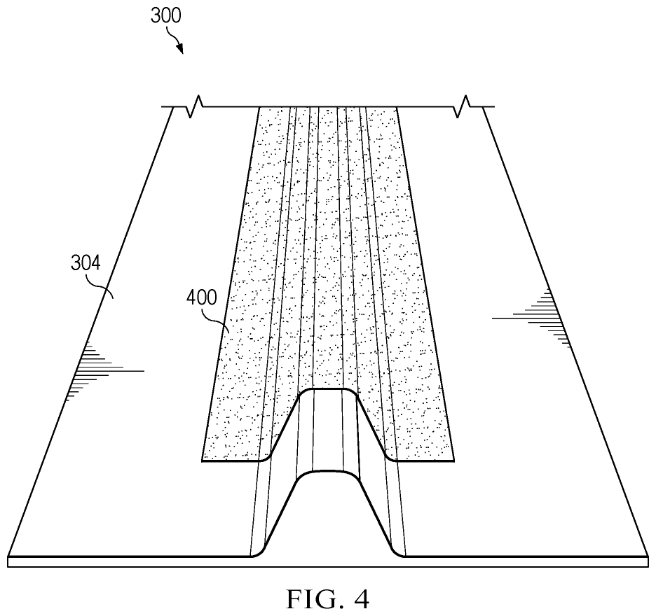

FIG. 4 illustrates a perspective view of system 300. As better illustrated in FIG. 4, and for purposes of example only, and as will be illustrated in additional figures herein, form tool 304 is designed for forming an omega-shaped wing stiffener. It will be recognized, however, that other shapes of form tools 304 for forming other composite parts may be provided without departing from the spirit or scope of the disclosure provided herein. As described above with reference to FIG. 3, one or more portions of form tool 304 may be formed from a porous granular material 400 for forming an airtight seal with materials in contact therewith when vacuum source 302 (not shown in FIG. 4) is engaged.

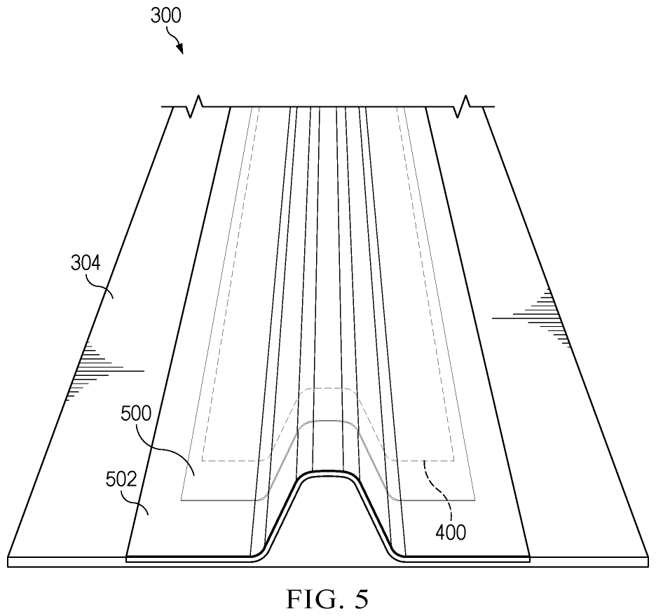

FIG. 5 illustrates a perspective view of the system 300 after a release film 500 is overlaid on form tool 304. As shown in FIG. 5, edges of release film 500 may be secured to surfaces of form tool 304 not including material 400, e.g., using tape 502 or other appropriate means. In accordance with features of embodiments described herein, once release film 500 is overlaid on form tool 304, vacuum source may be engaged such that release film is “sucked” inward toward surfaces of form tool 304 comprising material 400.

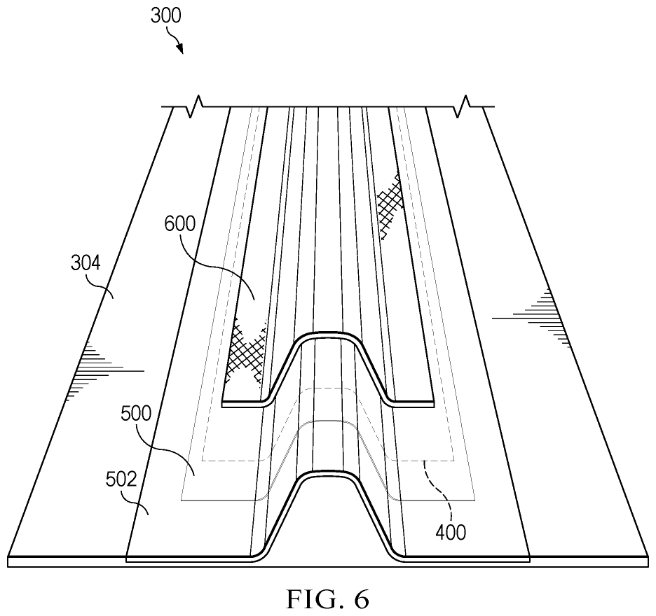

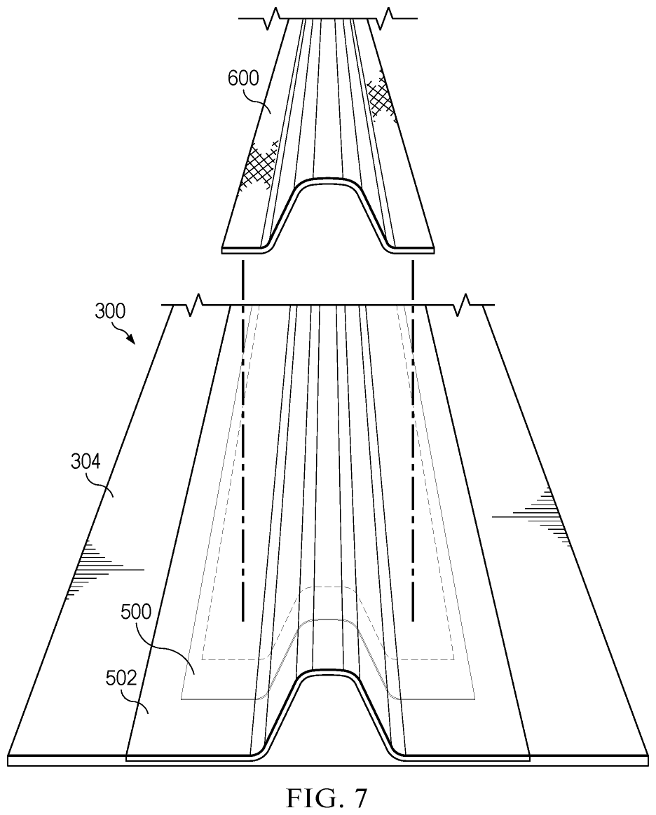

FIG. 6 illustrates a perspective view of the system 300 after a composite part 600 has been laid up on form tool 304. As noted above, in the illustrated embodiment, composite part 600 comprises an omega-shaped wing stiffener, although system 300 may be advantageously used to lay up other composite parts for aircraft and/or other applications without departing from the spirit or scope of embodiments described herein. Once composite part 600 has been laid up on form tool 304, vacuum source may be disengaged such that release film 500 is released from airtight contact with form tool 304 and composite part 600 may be easily lifted from form tool 304 and release film 500 (which remains attached to form tool 304 via tape 502, for example), as shown in FIG. 7, and cured in a curing tool after release film 500 is removed therefrom.

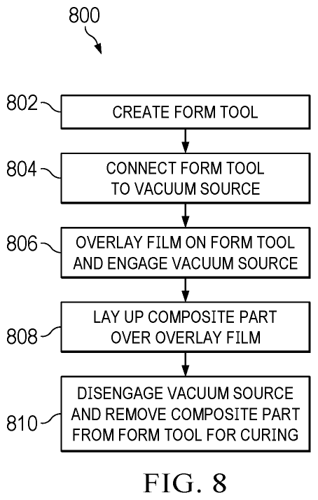

FIG. 8 is a flow diagram 800 illustrating operations performed in connection with techniques for release of composite material from a form layup tool in accordance with features of embodiments described herein.

In step 802, the form tool is created. In particular portions of the form tool are machined or otherwise formed from the porous granular material described above. The shape of the form tool should be appropriate for laying up sheets or other formats of prepreg composite material to form a component in a desired shape.

In step 804, the form tool created in step 802 is connected to a vacuum source. As described above, when the vacuum source is connected to the form tool and subsequently engaged, vacuum pressure will be applied to the form tool. When the vacuum source is disengaged, vacuum pressure ceases to be applied to the form tool.

In step 806, release film is overlaid on the for tool. The release film may optionally be secured to the form tool or to a surface on which the form tool is supported using tape or other material. Also in step 806, the vacuum source is engaged such that vacuum pressure is applied to the form tool, securing the film to the surface of the porous granular material.

In step 808, a composite sheets are laid up on the form tool to form the composite part.

In step 810, the vacuum source is disengaged and the composite part is removed from the form tool. The composite part (after removal of the release film) may then be transferred to a curing tool for curing. It should be recognized that in alternative embodiments, the vacuum source may remain engaged until after the composite part is removed, in which case the release film may remain secured to the form tool, while the composite part is removed from the form tool/release film.

Although the operations of the example method shown in and described with reference to FIG. 8 are illustrated as occurring once each and in a particular order, it will be recognized that the operations may be performed in any suitable order and repeated as desired. Additionally, one or more operations may be performed in parallel. Furthermore, the operations illustrated in FIG. 8 may be combined or may include more or fewer details than described.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method of forming a composite part, the method comprising:
connecting a layup form tool to a vacuum source;
overlaying a release film on a surface of the layup form tool;
engaging the vacuum source to affix the release film to the surface of the layup form tool using vacuum pressure;
overlaying at least one sheet of composite material on the release film affixed to the surface of the layup form tool to form the composite part; and
removing the formed composite part from the layup form tool.

2. The method of claim 1, further comprising, prior to the connecting, forming the layup form tool from a porous granular material.

3. The method of claim 2, wherein the forming further comprises machining the porous granular material.

4. The method of claim 1, wherein the overlaying at least one sheet of composite material further comprises overlaying a plurality of sheets of composite material over the release film affixed to the layup form tool surface.

5. The method of claim 1, further comprising, subsequent to the removing:
transferring the formed composite part to a cure tool; and
curing the formed composite part using the cure tool.

6. The method of claim 5, further comprising disengaging the vacuum source prior to the removing.

7. The method of claim 6, further comprising removing the release film from a bottom surface of the removed component part prior to the curing.

8. The method of claim 1, further comprising disengaging the vacuum source subsequent to the removing.

9. An apparatus comprising:
a form tool comprising a porous surface, the form tool for layup of a composite component; and
a vacuum source for providing vacuum pressure to the form tool when the vacuum source is engaged;
wherein a release film is overlaid on the form tool and secured to the form tool by the vacuum pressure provided to the form too by the vacuum source prior to laying up the composite component on the form tool.

10. The apparatus of claim 9, wherein the porous surface of the form tool comprises a porous granular material.

11. The apparatus of claim 9, wherein subsequent to completion of layup of the composite component, the composite component is removed from the form tool while the release film is secured to the form tool.

12. The apparatus of claim 9, wherein subsequent to completion of layup of the composite component, the vacuum source is disengaged prior to the composite component being removed from the form tool.

13. The apparatus of claim 9, wherein the composite component comprises layers of preimpregnated composite material.

14. The apparatus of claim 9, wherein the composite component comprises an aircraft component.

15. The apparatus of claim 9, wherein the vacuum source comprises a vacuum chuck.

16. A layup fixture for a composite component, the fixture comprising:
a form tool comprising a porous surface, the form tool for layup of a composite component and supported on a table;
a vacuum source for providing vacuum pressure to the form tool when the vacuum source is engaged; and
release film overlaid on the form tool, wherein at least one edge of the release film is affixed to a surface of the table with an adhesive material and wherein the release film is secured to the porous surface by vacuum pressure when the vacuum source is engaged;
wherein at least one layer of composite material is overlaid on the release film to form the composite component.

17. The fixture of claim 16, wherein additional layers of composite material are overlaid on the at least one layer of composite material to form the composite component.

18. The fixture of claim 16, wherein after completion of formation of the composite component, the vacuum source is disengaged prior to removing the composite component from the form tool.

19. The fixture of claim 16, wherein after completion of the composite component, the vacuum source is disengaged after removing the composite component from the form tool.

20. The fixture of claim 16, wherein the porous surface of the form tool comprises a porous granular material.
